(19) United States
(12) Patent Application Publication
(10) Pub. No.: US 2026/0326282 A1
(43) Pub. Date: Oct. 22, 2026

(54) CHAINSAW REPLACEMENT CHAIN STORAGE DEVICE

(71) Applicant: Brian Burge, Marion, SD (US)

(72) Inventor: Brian Burge, Marion, SD (US)

(21) Appl. No.: 19/051,690

(22) Filed: Feb. 12, 2025

(51) Int. Cl. B25H 3/00; B25H 3/02; B27B 17/00

(52) U.S. Cl. CPC B25H 3/006; B25H 3/02; B27B 17/00

(57) ABSTRACT

A chainsaw replacement chain storage device includes a container having back wall, a base wall coupled to and extending from the back wall, a pair of lateral walls coupled to and extending forwardly from the back wall, and a front wall coupled to and extending between the pair of lateral walls and the base wall. The container defines an interior space. Each of a plurality of dividers extends between the pair of lateral walls defining a plurality of slots within the interior space. Each of the slots receives a respective chainsaw chain. A lid is engageable to the container to cover the interior space.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to chainsaw chain packaging devices and more particularly pertains to a new chainsaw chain packaging and storage device for selling and storing replacement chainsaw chains.

### (2) Description of Related Art Including Information Disclosed Under 37 CFR 1.97 and 1.98

The prior art relates to chainsaw chain packaging devices. Known packaging or storage provides for individual or single chain packaging and lacks storage capability at a site for multiple replacement chains securable to a mount or on a supporting surface.

### (h) BRIEF SUMMARY OF THE INVENTION

An embodiment of the disclosure meets the needs presented above by generally comprising a container having back wall, a base wall coupled to and extending from the back wall, a pair of lateral walls coupled to and extending forwardly from the back wall, and a front wall coupled to and extending between the pair of lateral walls and the base wall. The container defines an interior space. Each of a plurality of dividers extends between the pair of lateral walls defining a plurality of slots within the interior space.

Each of the slots receives a respective chainsaw chain. A lid is engageable to the container to cover the interior space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded top front side perspective view of a chainsaw replacement chain storage device according to an embodiment of the disclosure.

FIG. 2 is a top front side perspective view of an embodiment of the disclosure.

FIG. 3 is a side view of an embodiment of the disclosure.

FIG. 4 is a back view of an embodiment of the disclosure.

FIG. 5 is a cross-sectional view of an embodiment of the disclosure along line 5-5 of FIG. 4.

FIG. 6 is a top view of an embodiment of the disclosure.

### (J) DETAILED DESCRIPTION OF THE INVENTION

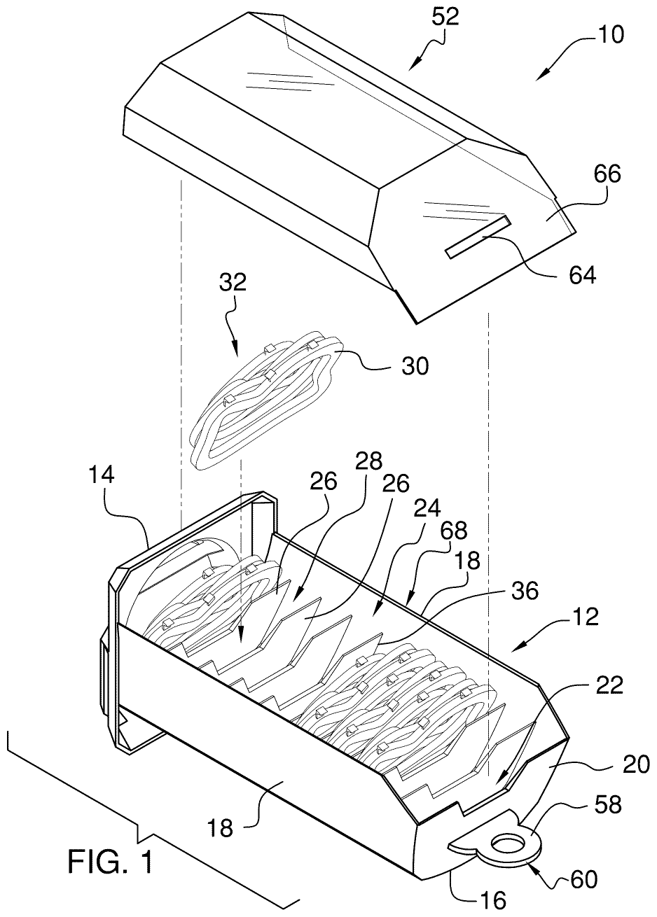

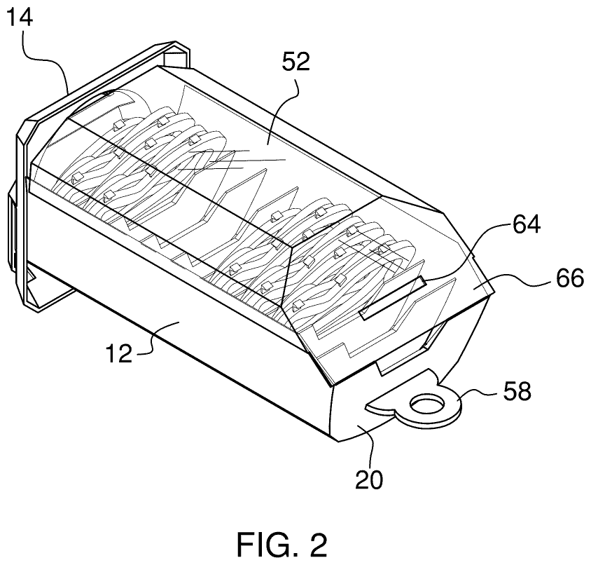

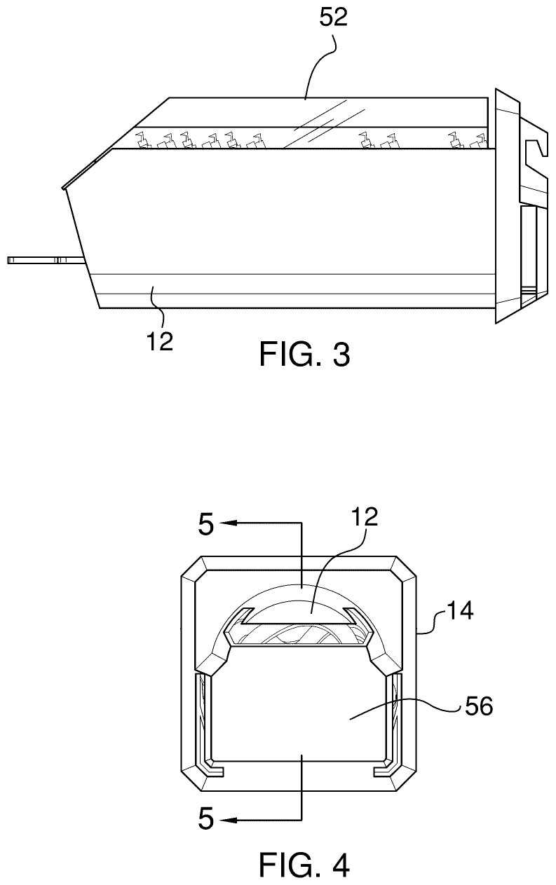

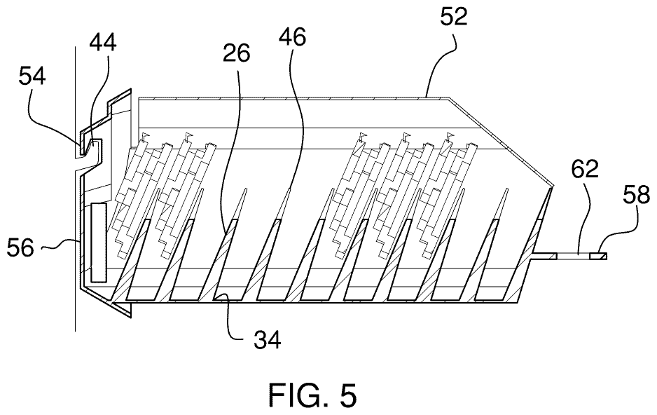

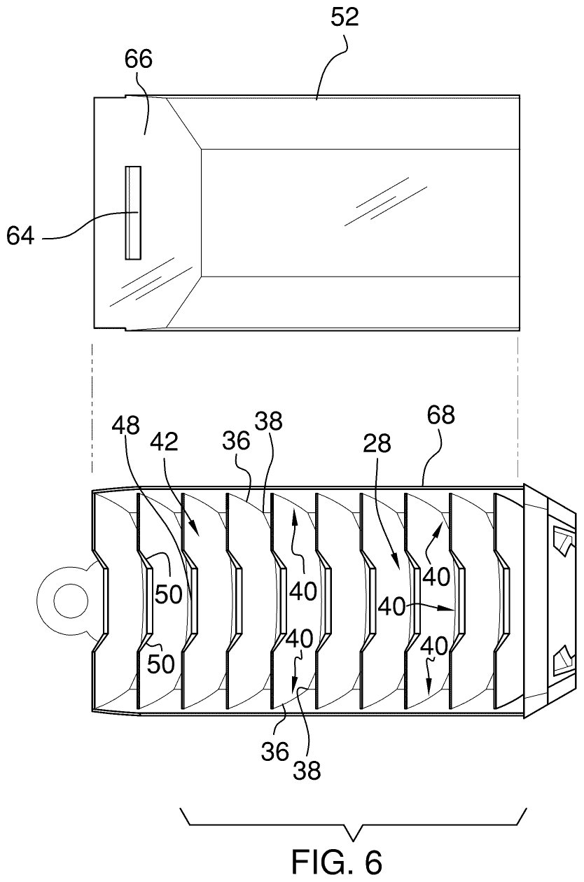

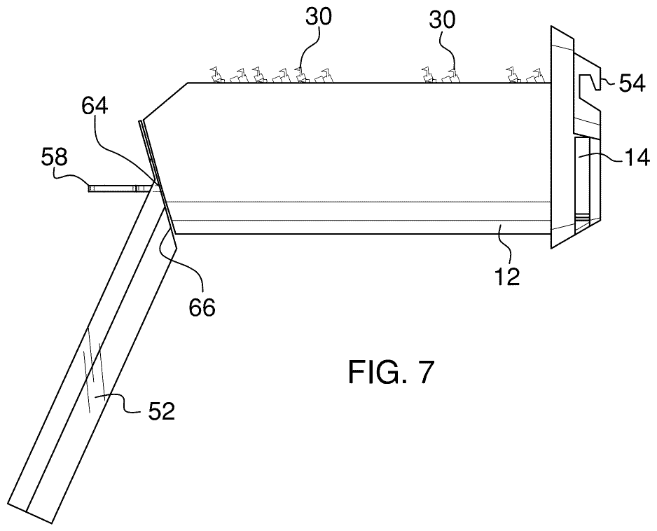

With reference now to the drawings, and in particular to FIGS. 1 through 6 thereof, a new chainsaw chain packaging device embodying the principles and concepts of an embodiment of the disclosure and generally designated by the reference numeral 10 will be described.

As best illustrated in FIGS. 1 through 6, the chainsaw replacement chain storage device 10 generally comprises a container 12 having back wall 14, a base wall 16 coupled to and extending from the back wall 14, a pair of lateral walls 18 coupled to and extending forwardly from the back wall 14, and a front wall 20 coupled to and extending between the pair of lateral walls 18 and the base wall 16. The front wall 20 has a middle cutout 22. The container 12 defines an interior space 24. Each of a plurality of dividers 26 is positioned in the container 12. Each of the dividers 26 extends between the pair of lateral walls 18 defining a plurality of slots 28 within the interior space 24. Each of the slots 28 is configured for receiving a respective chainsaw chain 30 in a folded position 32. A respective base edge 34 of each of the dividers 26 is coupled to the base wall 16. Lateral ends 36 of each of the dividers 26 are coupled to the pair of lateral walls 18. Each lateral end 36 of each divider 26 has a bend 38 such that each slot 28 has five closed edges 40 and an open top 42. This helps to inhibit contamination or debris between the chains 30 in the slots 28. Each of the dividers 26 is angled to extend upwardly relative to the base wall 16 and forwardly relative to the back wall 14 such that each slot 28 receives the respective chainsaw chain 30 such that gravity urges the respective chainsaw chain 30 into the slot 28 when the container 12 is positioned with the back wall 14 or the base wall 16 in a horizontal orientation. The horizontal orientation may be achieved by either resting on a supporting surface or being suspended or hung from a mount 44 as further described below. Each of the dividers 26 has a top edge 46 having a medial cutout 48.

Each medial cutout 48 has flared outer edges 50 such that each medial cutout 48 is trapezoidal shaped. The middle cutout 22 of the front wall 20 is similarly shaped and linearly aligned with the medial cutouts 48 of the dividers 26 to facilitate access and removal of each chain 30. A lid 52 is engageable to the container 12 wherein the lid 52 covers the interior space 24. Collectively, the container 12 and lid 52 may be used as packaging for consumer sale of an array of chains 30.

A hook 54 is coupled to the back wall 14 such that the back wall 14 can be attached to the mount 44. The hook 54 may be an integral formation of a rear surface 56 of the back wall 14. A tab 58 is coupled to the front wall 20 of the container 12. The tab 58 extends from the front wall 20 away from the rear wall 14 of the container 12. The tab 58 is planar and has a horseshoe arch perimeter shape 60. A horseshoe arch is defined as a segmented shape having a central arc extending through more than a semi-circle, and two identical reversed, side arcs each spanning less than a quarter circle. An aperture 62 extends through the tab 58 such that the tab 58 is configured for hanging the container 12 from the mount 44.

A slit 64 extends through the lid 52. The slit 64 is complementary to the tab 58 such that the tab 58 is positionable extending through the slit 64 to support the lid 52 on the tab 58. The slit 64 is positioned in an angled surface 66 of the lid 52 wherein the lid 52 is positionable to extend forwardly relative to the front wall 20 and downwardly relative to the base wall 14 when the tab 58 is fully inserted through the slit 64. A seal 68 may be coupled to one of the lid 52 and the container 12 such that the lid 52 seals to the container 12 when the lid 52 is engaged to the container 12. The seal 68 may be achieved through positioning of a gasket or may be achieved through other engagement of the lid 52 to the container 12 such as but not limited to a tongue in groove or other conventional lid to container engagement.

In use, multiple replacement chains 30 are positioned in the slots 28 of the container 12 and covered by the lid 52. This packaging may be used for commercial display and sale of the chains 30. The container 12 may then be placed on a supporting surface at a site or attached to the mount 44 at the site. This provides for efficient storage and access to a replacement chain 30 as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A chainsaw replacement chain storage device comprising:
a container having back wall, a base wall coupled to and extending from said back wall, a pair of lateral walls coupled to and extending forwardly from said back wall, and a front wall coupled to and extending between said pair of lateral walls and said base wall, said container defining an interior space;
a plurality of dividers positioned in said container, each of said dividers extending between said pair of lateral walls defining a plurality of slots within said interior space, each of said slots being configured for receiving a respective chainsaw chain; and
a lid, said lid being engageable to said container wherein said lid covers said interior space.

2. The chainsaw replacement chain storage device of claim 1, further comprising lateral ends of each of said dividers being coupled to said pair of lateral walls.

3. The chainsaw replacement chain storage device of claim 2, further comprising a respective base edge of each of said dividers being coupled to said base wall.

4. The chainsaw replacement chain storage device of claim 3, further comprising each lateral end of each divider having a bend wherein each slot has five closed edges and an open top.

5. The chainsaw replacement chain storage device of claim 1, further comprising each of said dividers being angled to extend upwardly relative to said base wall and forwardly relative to said back wall wherein each slot is configured for receiving the respective chainsaw chain such that gravity urges the respective chainsaw chain into said slot when said container is positioned with said back wall or said base wall in a horizontal orientation.

6. The chainsaw replacement chain storage device of claim 1, further comprising each of said dividers having a top edge, said top edge having a medial cutout.

7. The chainsaw replacement chain storage device of claim 6, further comprising each medial cutout having flared outer edges wherein each medial cutout is trapezoidal shaped.

8. The chainsaw replacement chain storage device of claim 1, further comprising a hook coupled to said back wall wherein said back wall is configured to be attached to a mount.

9. The chainsaw replacement chain storage device of claim 8, wherein said hook is an integral formation of a rear surface of said back wall.

10. The chainsaw replacement chain storage device of claim 1, further comprising a tab coupled to said front wall of said container, said tab extending from said front wall away from said rear wall of said container.

11. The chainsaw replacement chain storage device of claim 10, further comprising an aperture extending through said tab wherein said tab is configured for hanging said container from a mount.

12. The chainsaw replacement chain storage device of claim 10, further comprising a slit extending through said lid, said slit being complementary to said tab wherein said tab is positionable extending through said slit such that said lid is supportable on said tab.

13. The chainsaw replacement chain storage device of claim 12, further comprising said slit being positioned in an angled surface of said lid wherein said lid is positionable to extend forwardly relative to said front wall and downwardly relative to said base wall when said tab is fully inserted through said slit.

14. The chainsaw replacement chain storage device of claim 11, further comprising said tab being planar and having a horseshoe arch perimeter shape.

15. The chainsaw replacement chain storage device of claim 6, further comprising said front wall having a middle cutout, said middle cutout being linearly aligned with said medial cutouts of said dividers.

16. The chainsaw replacement chain storage device of claim 1, further comprising a seal coupled to one of said lid and said container wherein said lid seals to said container when said lid is engaged to said container.

17. A chainsaw replacement chain storage device comprising:
a container having back wall, a base wall coupled to and extending from said back wall, a pair of lateral walls coupled to and extending forwardly from said back wall, and a front wall coupled to and extending between said pair of lateral walls and said base wall, said front wall having a middle cutout, said container defining an interior space;
a plurality of dividers positioned in said container, each of said dividers extending between said pair of lateral walls defining a plurality of slots within said interior space, each of said slots being configured for receiving a respective chainsaw chain, a respective base edge of each of said dividers being coupled to said base wall, lateral ends of each of said dividers being coupled to said pair of lateral walls, each lateral end of each divider having a bend wherein each slot has five closed edges and an open top, each of said dividers being angled to extend upwardly relative to said base wall and forwardly relative to said back wall wherein each slot is configured for receiving the respective chainsaw chain such that gravity urges the respective chainsaw chain into said slot when said container is positioned with said back wall or said base wall in a horizontal orientation, each of said dividers having a top edge, said top edge having a medial cutout, each medial cutout having flared outer edges wherein each medial cutout is trapezoidal shaped, said middle cutout of said front wall being linearly aligned with said medial cutouts of said dividers;
a lid, said lid being engageable to said container wherein said lid covers said interior space;
a hook coupled to said back wall wherein said back wall is configured to be attached to a mount, said hook being an integral formation of a rear surface of said back wall;
a tab coupled to said front wall of said container, said tab extending from said front wall away from said rear wall of said container, said tab being planar and having a horseshoe arch perimeter shape;
an aperture extending through said tab wherein said tab is configured for hanging said container from a mount;
a slit extending through said lid, said slit being complementary to said tab wherein said tab is positionable extending through said slit such that said lid is supportable on said tab, said slit being positioned in an angled surface of said lid wherein said lid is positionable to extend forwardly relative to said front wall and downwardly relative to said base wall when said tab is fully inserted through said slit; and
a seal coupled to one of said lid and said container wherein said lid seals to said container when said lid is engaged to said container.
